(19) United States
(12) Patent Application Publication
(10) Pub. No.: US 2016/0339832 A1
(43) Pub. Date: Nov. 24, 2016

(54) ELONGATE LOGISTICS TRACK

(71) Applicant: KINEDYNE LLC, BRANCHBURG, NJ (US)

(72) Inventors: TODD R. ROBINSON, NAZARETH, PA (US); TODD A. JENKINS, MONTGOMERY, AL (US)

(73) Assignee: KINEDYNE LLC, BRANCHBURG, NJ (US)

(21) Appl. No.: 15/141,285

(22) Filed: Apr. 28, 2016

Related U.S. Application Data
(60) Provisional application No. 62/155,298, filed on Apr. 30, 2015.

(51) Int. Cl. B60P 7/15; B65D 90/00; F16M 13/02

(52) U.S. Cl. CPC B60P 7/15; F16M 13/02; B65D 90/0073

(57) ABSTRACT

An elongate track is provided. The track includes an elongate member includes a plurality of first holes that disposed therealong and a plurality of second holes that are disposed along a length of the elongate member and extend through the first and second sides of the elongate member. Each of the plurality of second holes include an first portion that extends through the first side of the elongate member, and a cylindrical second portion that extends through the second side of the elongate member. The second side of the elongate member defines a plurality of projections that each coaxially surround one of the plurality of second holes.

### CROSS-REFERENCE TO RELATED APPLICATIONS

This application claims priority from U.S. Provisional Application No. 62/155,298, filed on Apr. 30, 2015, the entirety of which is fully incorporated by reference herein.

### TECHNICAL FIELD

This disclosure relates to logistics tracks that are used to support and retain beams and other cargo control equipment within a cargo container.

### BRIEF SUMMARY

A first representative embodiment of the disclosure is provided. The embodiment includes an elongate track configured to be disposed in a cargo compartment. The track includes an elongate member that extends between first and second ends, the elongate member comprising a first side and an opposite second side and two opposite end faces that each bridge the first and second sides and extend from opposite first and second end surfaces. The elongate member comprises a plurality of first holes that disposed along at least a first portion of a length of the elongate member and extend through each of the first and second sides of the elongate member, and a plurality of second holes that are disposed along at least the first portion of a length of the elongate member and extend through the first and second sides of the elongate member. Each of the plurality of first holes are defined with the same size and shape, and each of the plurality of second holes are defined with the same size and shape that is different from the plurality of first holes. Each of the plurality of second holes include an first portion that extends through the first side of the elongate member, and a cylindrical second portion that extends through the second side of the elongate member. The second side of the elongate member defines a plurality of projections that each coaxially surround one of the plurality of second holes.

Another representative embodiment of the disclosure is provided. The embodiment includes a method of manufacturing an elongate track. The method includes the steps of obtaining an elongate rigid member that extends between first and second ends and aligning the elongate rigid member longitudinally with a first punch configured to form a first hole in the elongate rigid member and a second punch configured to form a second hole in the elongate rigid member, wherein the first hole is rectangular, and the second hole is formed from first and second coaxial sections, a first truncated conical section and a second cylindrical section that extends from a truncated end of the truncated conical section. The method further includes the step of punching the elongate rigid member through a first side of the elongate rigid member with the first and second punches to form the first and second holes, respectively. The method includes the step of translating the elongate rigid member longitudinally with respect to the first punch and the second punch to form another first hole and another second hole in the elongate rigid member that is spaced from the earlier punched first and second holes. The second punch is configured to establish a truncated conical projection that extends from a second side of the elongate rigid member, opposite from the first side, the truncated conical projection surrounding and coaxial with the second hole.

Other systems, methods, features and advantages of the invention will be, or will become, apparent to one with skill in the art upon examination of the following figures and detailed description. It is intended that all such additional systems, methods, features and advantages be within the scope of the disclosure, and be encompassed by the following claims.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1 is a perspective view of a first side of a track configured to support structural items within a cargo compartment, such as within a cargo compartment of a cargo trailer.

FIG. 2 is a perspective view of a second side of the track of FIG. 1.

FIG. 3 is a perspective view of Detail A of FIG. 1.

FIG. 4 is a perspective view of Detail B of FIG. 2.

FIG. 5 is a top view of the track of FIG. 1.

FIG. 6 is a cross-sectional view of section C-C of FIG. 5.

FIG. 7 is a cross-sectional view of a track of FIG. 1 connected to a trailer post wall 400 and disposed between internal walls 200 of a trailer.

FIG. 8 is a cross-sectional view of a prior art track that is connected to a trailer post wall 400 and disposed between internal walls 200 of a trailer.

FIG. 9 a partial perspective view of another track with consistent spacing between the first holes and the second holes along the length of the track.

FIG. 10 is a flowchart of a method of manufacturing an elongate track.

FIG. 11 is a perspective view of cargo compartment of a trailer with a plurality of tracks of FIG. 1 installed and receiving a captive beam system.

### DETAILED DESCRIPTION

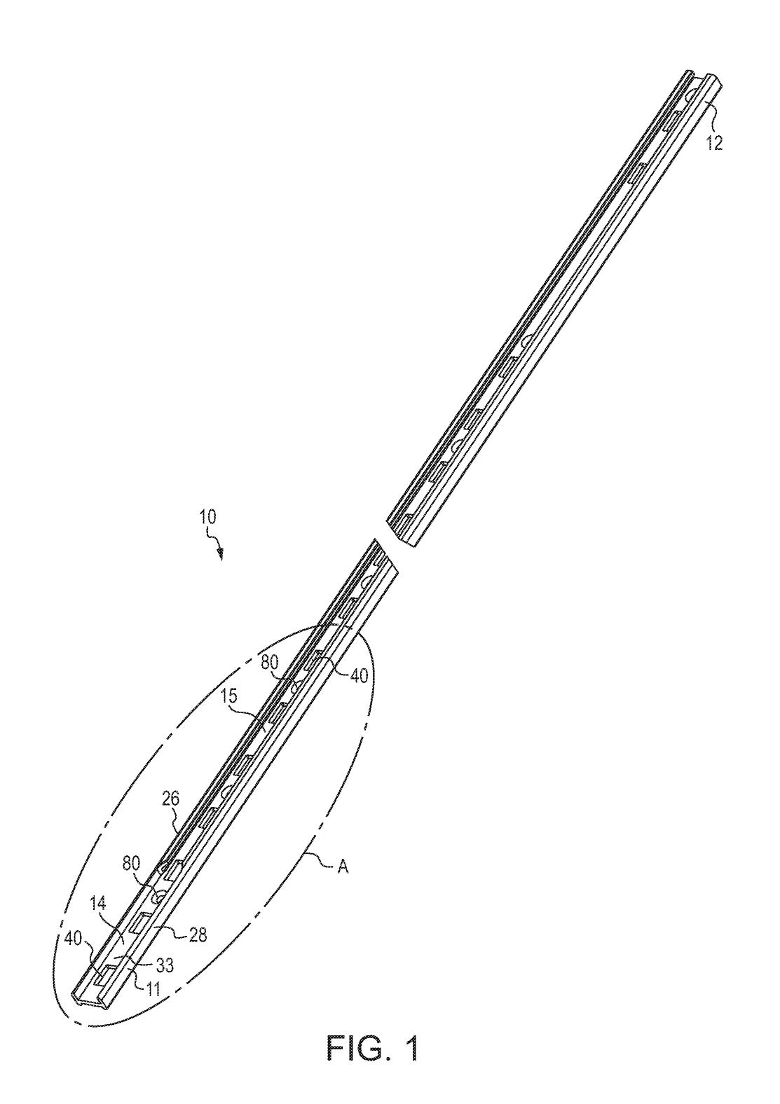

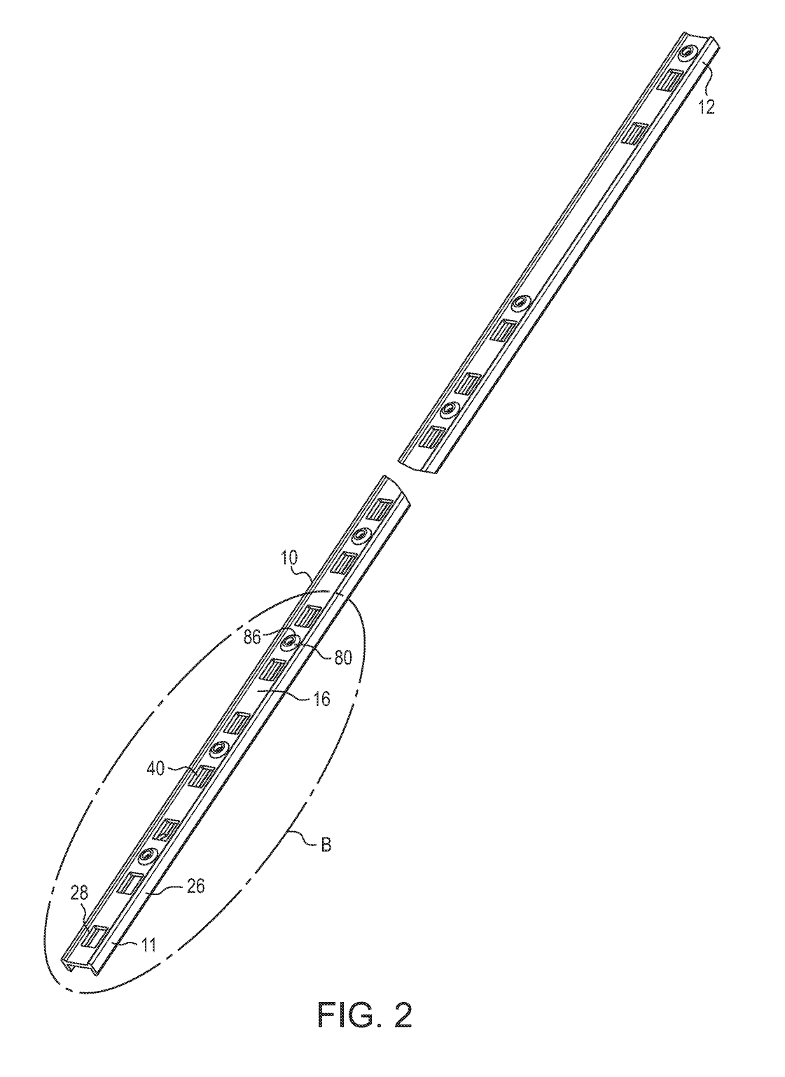

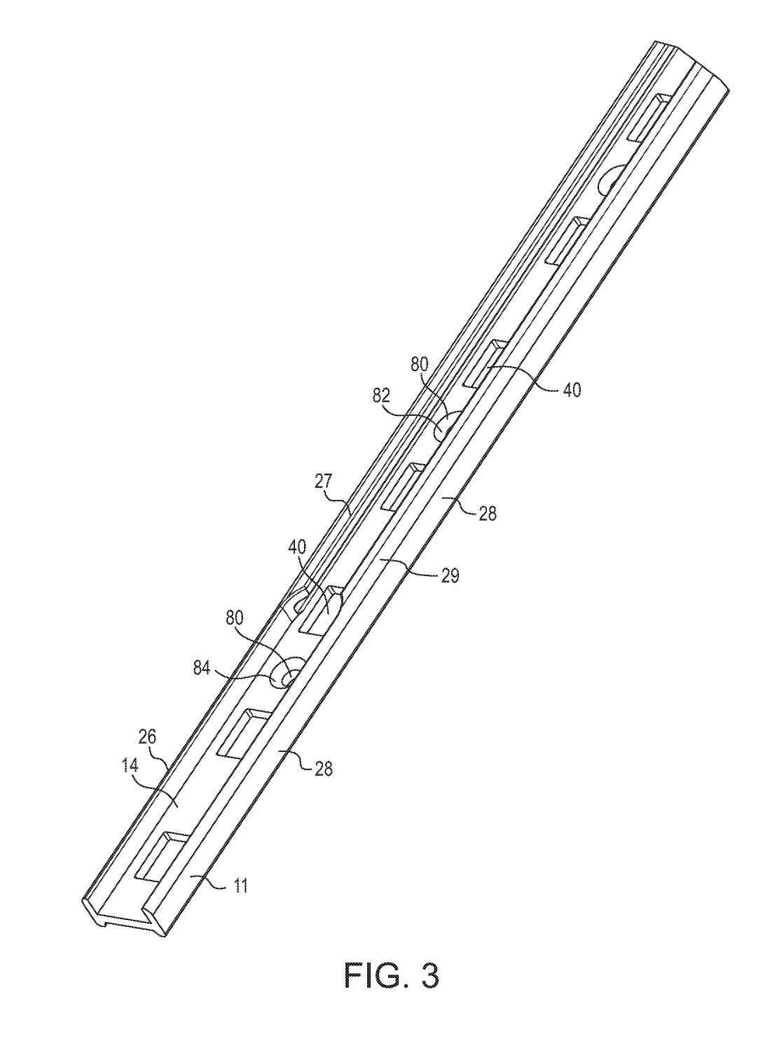

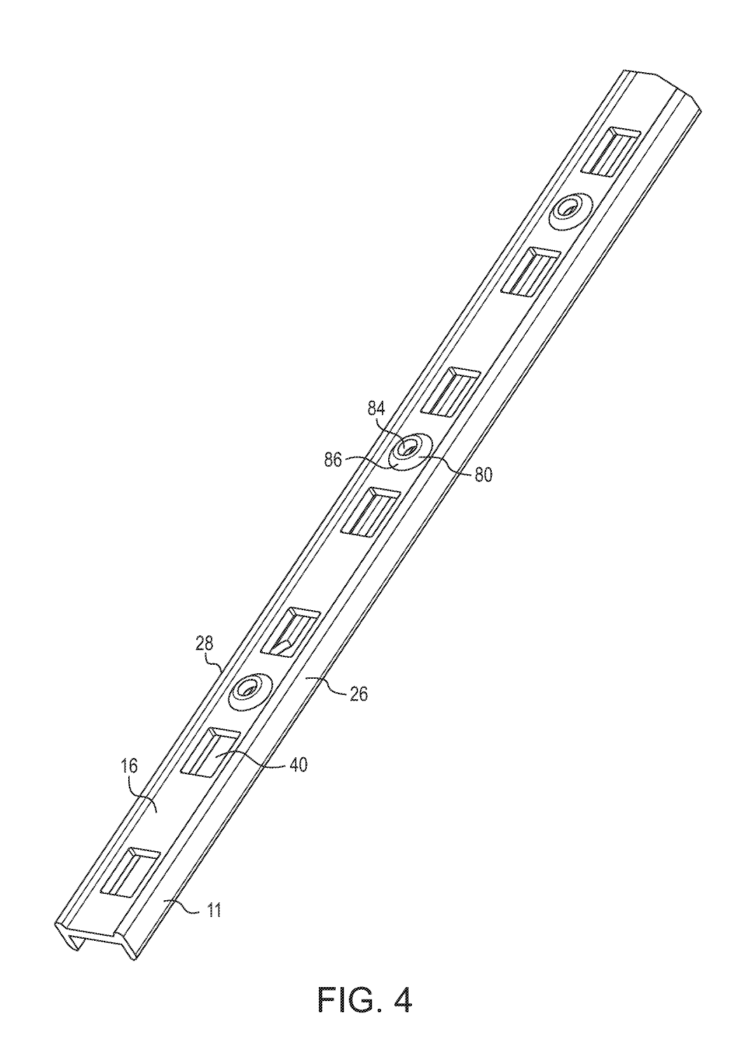

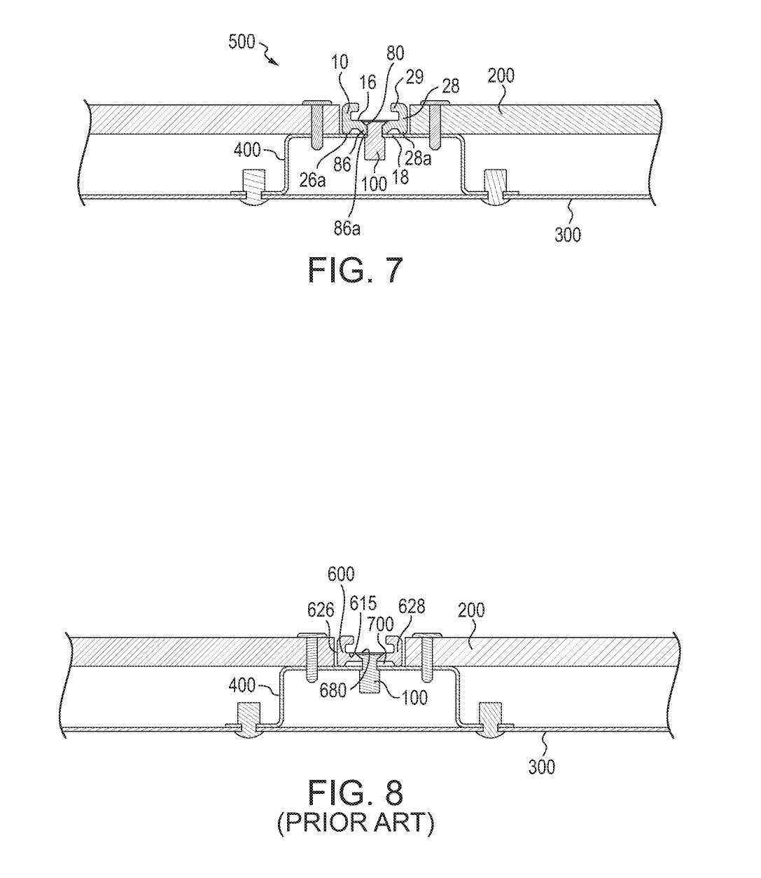

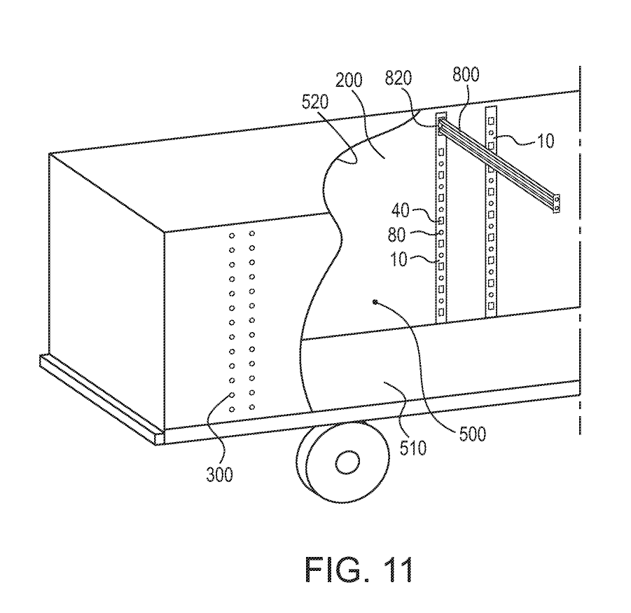

Turning now to FIGS. 1-7, an elongate track 10 such as a logistics track is provided. The elongate track 10 may fixed to or aligned with the inner walls 200 of a cargo or storage compartment 500 to receive beams 800 from a decking system (such as a captive decking system as depicted schematically in FIG. 11) or to receive connectors for other equipment that may be used in conjunction with a storage compartment, such as shelving, netting, tools, or the like. The track and captive decking system is depicted with respect to a cargo compartment of a conventional trailer, but one of ordinary skill in the art will understand after a thorough review of this disclosure that the track 10 disclosed herein can be suitably used in other transportation or storage systems such as railcars, boats, aircraft, or any stationary storage facilities. The elongate track 10 may be provided in pairs, with tracks disposed on opposite sides of a cargo or storage compartment 500, such as mounted upon or in conjunction with the opposite inner walls 200 of a cargo compartment 500 of a trailer. In some embodiments, as shown in FIG. 7, the elongate track 10 may be disposed upon the trailer wall post 400 of a trailer with a plurality of fasteners, such as rivets 100, screws, bolts, adhesive, or the like.

The elongate track 10 extends from a first end 11 to an opposite end 12. In embodiments where the elongate track 10 is disposed vertically, the first end 11 may be disposed in contact with or proximate to the floor 510 of the cargo compartment 500 (FIG. 11) and the opposite second end 12 may be disposed in contact with or proximate to the ceiling 520 of the cargo compartment 500.

The track 10 may include a central bridge portion 15 with opposite first and second surfaces 16, 18, with the track installed such that the first surface 16 faces the interior of the cargo compartment 500 and the second surface 18 faces toward the exterior wall (and as discussed below, in some embodiments a portion of the second surface 18 abuts the trailer wall post 400 or other solid structure of the trailer or other storage compartment). The track 10 may additionally include opposite first and second end walls 26, 28 that are disposed on opposite sides of the central bridge portion 15. In some embodiments the first and second end walls 26, 28 extend perpendicularly to the central bridge portion 15. In some embodiments, the first and second end walls 26, 28 include flanges 27, 29 (respectively) that each extend inwardly toward the opposite end wall and flange for at least a portion of the length of the elongate track 10. In embodiments with flanges 27, 29, a space 95 is formed between each flange and the central bridge portion 15. In some embodiments, a portion of the track 10, such as the first portion 11, is formed without flanges 27, 29 to allow a shoe 820 (shown schematically in FIG. 11) for a captive beam system to be inserted into the track (and retained within the space 95) and removed from the track, with the shoe 820 retained with respect to the track 10 when above the first portion 11 by the flanges 27, 29.

The track 10 may include a plurality of first holes 40 and a plurality of second holes 80 that are each spacingly disposed upon the track 10. The first holes 40 may be configured to receive a lug, a finger from a shoe (in embodiments when the track 10 is used to support a captive beam system) or another locking structure from a support member that is desired to be supported by the track 10. In some embodiments, the first hole 40 may be rectangular, square, circular, key-shaped, or in another suitable shape to receive a correspondingly shaped locking structure. While the first hole may have a geometric shape listed above (or another geometric shape) one of skill in the art will understand after a thorough review of this disclosure that the first hole 40 may only approximate that geometric shape, such as for example having rounded corners or edges as appropriate for simplified manufacturing or use. The plurality of first holes 40 may extend through the entire central bridge portion 15 between the opposite first and second surfaces 16, 18, while in other embodiments, the plurality of first holes 40 may extend blindly from the first surface 16 and into the central bridge portion 15.

The second holes 80 may be configured to accept a fastener, such as a rivet 100 (as shown in FIG. 7), a screw, a bolt, or the like therethrough to mechanically fix the track 10 to the wall structure of the cargo compartment.

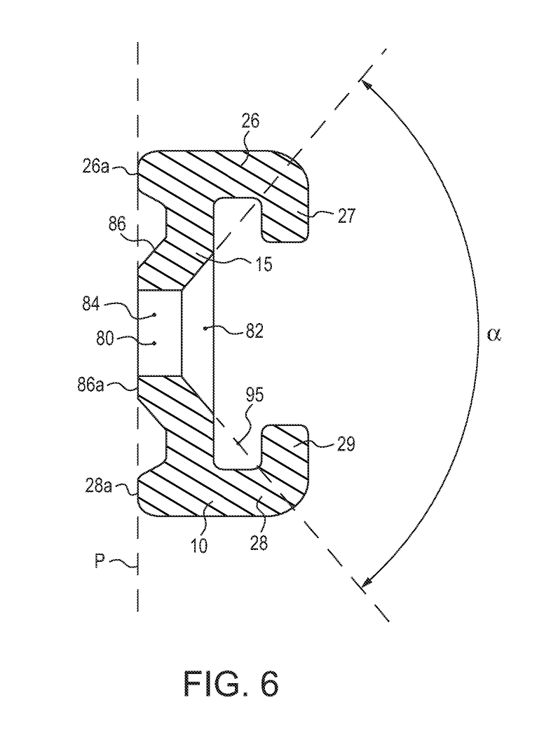

The second holes 80 may each include a first portion 82 and a coaxial second portion 84. The first portion 82 extends from the first surface 16 and extends blindly into the central bridge portion 15, and the second portion 84 extends from the end of the first portion 82 and reaches the second surface 18. The first portion 18 may be a countersunk portion and may be configured to receive the head of a fastener (such as a rivet 100, screw, or bolt) so that the head of the fastener is flush with or recessed below the first surface 16. In some embodiments, the first portion may be shaped as a truncated cone (as best shown in FIG. 6), while in other embodiments, the first portion 82 may be cylindrical, square, or another other geometry that includes a void sufficient to allow for the head of the fastener to be positioned flush or blow the first surface.

In some embodiments, where the first portion 82 is shaped as a truncated cone, the angle of the walls may be formed with an opening angle a that may be similar to an angled head of a rivet 100, screw, or other fastener. In some embodiments, the opening angle a may be within the range of about 80 degrees to about 120 degrees, inclusive of all angles within this range. In some specific embodiments, the angle may be about 100 degrees. The use of the term “about” is defined herein to be plus or minus 5 degrees from the specific angle that bounds the range. In other uses of “about” herein that do not refer to angular values, the term “about” is defined to refer to plus or minus 5% of the recited value. In some embodiments, the first portion 82 of each of the plurality of second holes has a depth of within a range of about 0.08 inches to about 0.12 inches, and in some embodiments of about 0.1 inch. One of skill in the art with a thorough review of this specification will understand that the depth of the first portion 82 may be different depending upon the thickness of the material forming the central bridge portion 15 and the depth of the head of the fastener that is to be used to fix the track 10 to the trailer post wall 400 (or other structure) and similarly the angle a may also differ from the range disclosed herein depending upon the size and geometry of the fastener to be received therein.

The second portion 84 of the second hole may be cylindrical along its length.

The second surface 18 may be generally planar with a plurality of extended portions that surround each of the second holes 80. In some embodiments, the extended portions may be projections 86 that result from the material forming the central bridge portion 15 of the track 10 being pressed in the direction of the second surface 18 when the first portion 82 of the hole 84 is formed with a stamping process (discussed in further detail below). In embodiments where the first portion 82 of the hole 80 defines a truncated cone (with a hole through the center), the projection 86 similarly forms a truncated cone, with the ring portion 86a (i.e. the planar surface of the truncated cone) forms the outer surface 18 of the track 10 at that position.

In some embodiments, the track 10 is formed such that the ring portion 86a is disposed along the same plane (P, FIG. 6) as the rear end portions 26a, 28a of the first and second end walls 26, 28, such that each of the ring portion 86a and the first and second walls 26, 28 contact a flat surface that the track 10 rests upon.

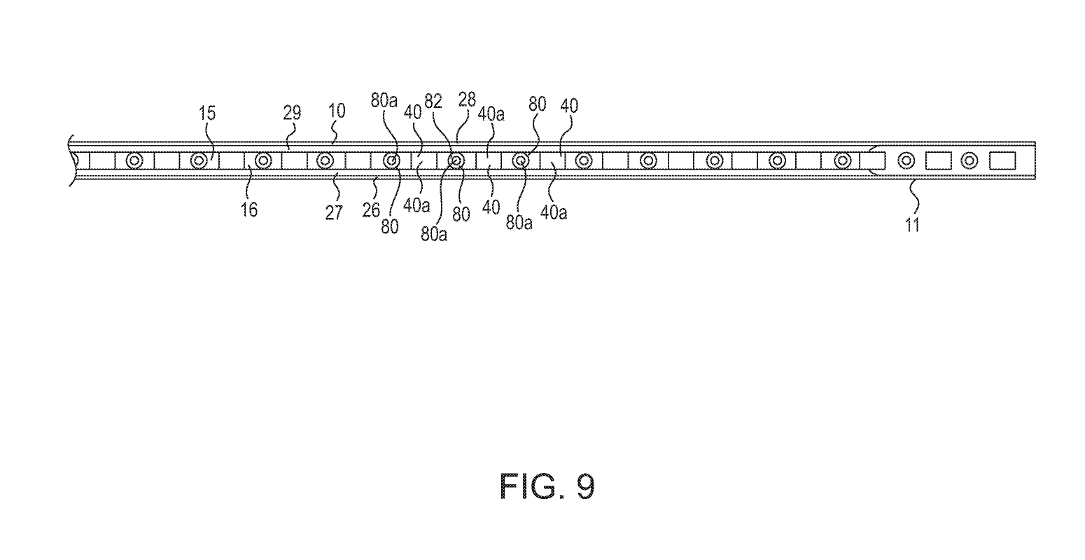

In some embodiments, the track 10 may be symmetrical about a longitudinal axis 1 that extends along the length of the track 10 between the first and second ends 11, 12. In some embodiments, the plurality of first holes 40 and the plurality of second holes 80 may be disposed in an alternating pattern with a consistent spacing between the centers of each of the first holes 40, a consistent spacing between the centers of each of the second holes 80, and in some embodiments with a consistent spacing between the centers of neighboring first and second holes 40, 80 along at least a portion of the length of the track 10 (FIG. 9). In some embodiments, the track may be formed with a spacing of 2 inches, 2.5 inches, 3 inches, 3.5 inches, 4 inches or other consistent spacing between the centers 40a of each of the plurality of first holes, at least in the central portion 13 of the track, and in other embodiments to one or both of the first and second ends 11, 12 of the track 10.

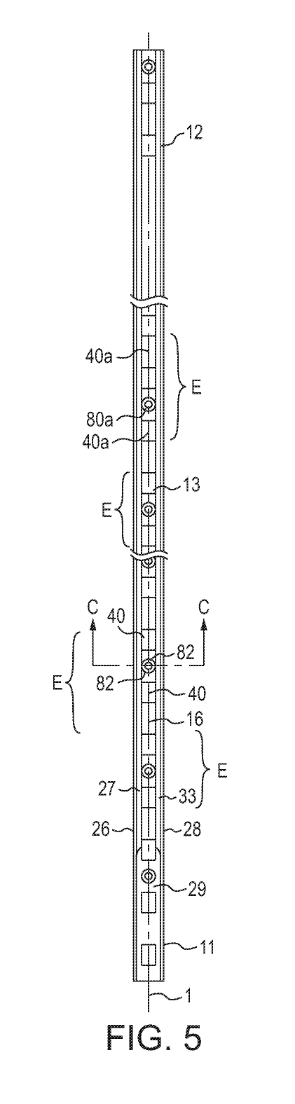

In other embodiments depicted in FIG. 5, the track 10 may include a plurality of subgroups E of respective first and second holes 40, 80, with each subgroup E spaced from other subgroups E with a consistent spacing along a first portion of the track 10 (such as along a central portion 13 of the track 10). In some embodiments, each subgroup may include a first hole 40 adjacent to and spaced from a second hole 80, which in turn is adjacent to and spaced from another first hole 40 (each in the same direction along the longitudinal axis 1 of the track 10). In some embodiments, the two first holes 40 on opposite sides of the second hole 80 are disposed with centers 40a at the same distance from the center 80a of the second hole 80.

FIG. 7 depicts a cross-sectional view of the track 10 fixed to the trailer wall post 400 and disposed between opposite inner walls 200 of the cargo compartment 500. As shown in the figure, the ring portion 86a of the projection 86 contacts the surface of the trailer wall post 400 and the rear end portions 26a, 28a of the first and second end walls 26, 28 also contact the trailer wall post 400. The surface-to-surface contact between the ring portion 86a and the trailer wall post 400 provides a strong connection therebetween and allows the rivet 100 when installed to sandwich the track 10 and trailer wall post 400 together such that the load carried by the track 10 (when receiving beams or other structures that are connected to one or more of the first holes 40 upon the track) is transferred to the trailer wall post 400 in purely tension and shear forces, which then may be transferred to other structural members of the trailer (or storage volume).

FIG. 8 depicts a cross-sectional view of a prior art track 600. The track 600 includes a central bridge portion 615, two end walls 626, 628, and second hole 680 therethrough. The second hole 680 of the prior art track is machined by removing the material to define the second hole 680 by a drill press or similar boring machine. Because the second hole is machined, the second side 618 of the central bridge portion 615 does not contact the trailer wall post 400 when attached thereto (with rivets 100, screws, or the like). Instead, a gap 700 exists between the second side 618 of the central bridge portion 615 and the trailer wall post 400 which limits the force that may be transferred to the trailer wall post 400 from the rivet 100 and its surrounding structure. Additionally, in this prior art arrangement, the central bridge portion 615 may bend or deform with high applied loads. In contrast to the prior art track 600, the track 10 depicted in FIGS. 1-7 is not likely to bend or deform when carrying the same load, due to the engagement between the projection 86 and the trailer post wall 400.

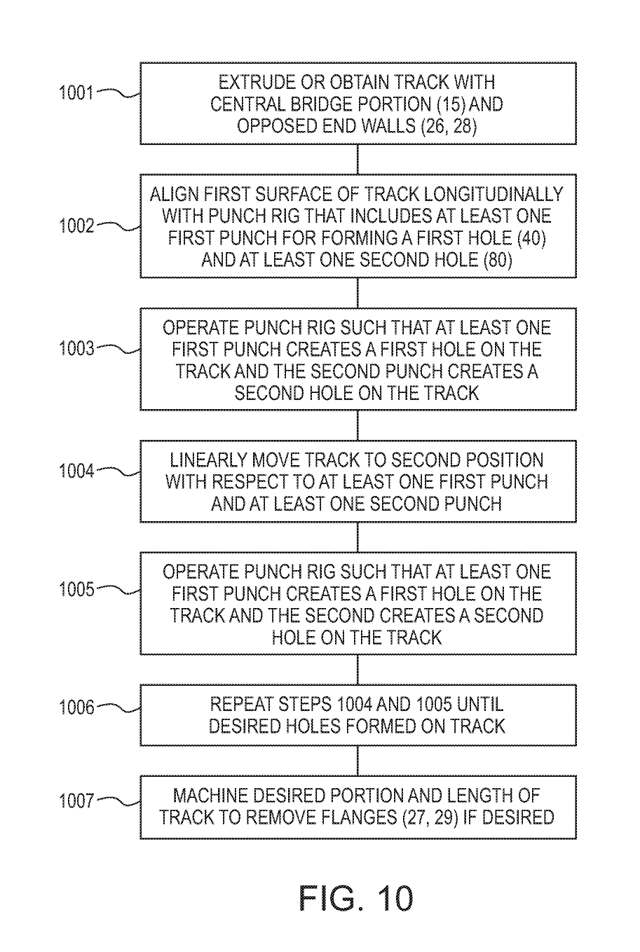

Turning now to FIG. 10, a method for forming a track 10 is provided. The track 10 may be extruded to form the shape of the central bridge portion 15, the two end walls 26, 28, and the flanges 27, 29 (when provided) (step 1001), or alternatively, a previously formed track stock may be acquired for use with the method. The extruded track is then aligned with a punch rig that includes at least one first punch configured to form the first holes 40 upon the track 10 and at least one second punch that is configured to form the second holes 80 (with first and second portions 82, 84, discussed above) upon the track 10 (step 1002) and cause each of the at least one first punch to form a first hole 40 onto the track and each of the at least one second punch to form a second hole on the track 10 (step 1003). In embodiments where the track includes flanges 27, 29, a gap between the internal ends of the flanges 27, 29 may be larger than a diameter of the first portion 82 of each of the second holes 80 and a width of each of the first holes 40 so that the at least one first and second punches have clearance to extend through the gap to contact the first surface 16 of the central bridge portion 15 to form the first and second holes 40, 80.

After the at least one first and second punches interact with the track 10, the track is linearly moved to a second position with respect to the at least one first punch and the at least one second punch such that the first and second holes 40, 80 are disposed in a different location along the track 10 (step 1004) and cause each of the at least one first punch to form a first hole 40 onto the track and each of the at least one second punch to form a second hole on the track 10 (step 1005). The track 10 is then continued to be iteratively linearly moved with respect to the at least one first and second punches and punched to form the desired number of first and second holes 40, 80 at the desired spacing along the track 10 (step 1006). When all of the desired first and second holes 40, 80 are formed along the track 10, the first portion 11 of the track 10 (or in other embodiments other portion(s) of the track 10) may be machined to remove the flanges 27, 29 along a desired position and length of the track 10, such as in embodiments where a captive beam system is used with the track 10 to allow for a location where a shoe for the captive beam system can be installed and removed from the track 10 when the track 10 is fixed to the trailer walls (1007). In use, the tracks 10 maybe positioned and fixed upon the walls of the trailer (or other cargo or storage container) with rivets 100 or other fasteners, with the rivets 100 or other fasteners extending through the second holes 80 of the track to engage the trailer wall post 400 or other structure to support the track 10.

While particular elements, embodiments, and applications of the present invention have been shown and described, it is understood that the disclosure is not limited thereto because modifications may be made by those skilled in the art, particularly in light of the foregoing teaching. It is therefore contemplated by the appended claims to cover such modifications and incorporate those features which come within the spirit and scope of the disclosure.

1. An elongate track configured to be disposed in a cargo compartment, comprising:
an elongate member that extends between first and second ends, the elongate member comprising a first side and an opposite second side and two opposite end faces that each bridge the first and second sides and extend from opposite first and second end surfaces,
the elongate member comprising a plurality of first holes that are disposed along at least a first portion of a length of the elongate member and extend through each of the first and second sides of the elongate member, and a plurality of second holes that are disposed along at least the first portion of a length of the elongate member and extend through the first and second sides of the elongate member;
wherein each of the plurality of first holes are defined with the same size and shape, and wherein each of the plurality of second holes are defined with the same size and shape that is different from the plurality of first holes;
wherein each of the plurality of second holes include a first portion that extends through the first side of the elongate member, and a cylindrical second portion that extends through the second side of the elongate member,
wherein the second side of the elongate member defines a plurality of projections that each coaxially surround one of the plurality of second holes.

2. The elongate track of claim 1, wherein the first portion of each of the second holes forms a truncated cone and wherein the plurality of projections each form a truncated cone with a size and shape similar to the size and shape of the first portion of the second hole.

3. The elongate track of claim 1, wherein the elongate track includes a plurality of subgroups of respective first and second holes, with each of the subgroups spaced from each other along the first portion of the length of the elongate member, wherein each of the plurality of subgroups includes one of the plurality of first holes adjacent to and spaced from one of the plurality of second holes which in turn is adjacent to and spaced from another first hole with the respective first and second holes all extending along a longitudinal axis of the elongate member.

4. The elongate track of claim 3, wherein the first holes are equally spaced on opposite sides of the second hole in each subgroup.

5. The elongate track of claim 1, wherein the first holes and second holes are positioned upon the track in a pattern of first hole, second hole, first hole, and second hole.

6. The elongate track of claim 5, wherein a center of each first hole or second hole is evenly spaced from a center of each adjacent second hole or first hole along the first portion of the length of the elongate member.

7. The elongate track of claim 1, wherein each of the plurality of first holes is rectangular with a consistent profile extending through both the first and second sides of the elongate member.

8. The elongate track of claim 7, wherein the first hole has a plurality of corners that are rounded.

9. The elongate track of claim 1, wherein the second side of the elongate member includes a planar portion from which each of the projections extend, wherein the second end surface of each of the two opposite end faces extends past the planar portion.

10. The elongate track of claim 9, wherein the second end surface of each of the first and second sides extends to a plane that also extends through an end surface of each of the truncated conical projections.

11. The elongate track of claim 1, wherein the first end surface of each of the opposite end faces extends outwardly past the first side of the elongate member.

12. The elongate track of claim 10, wherein the first end surface of each of the opposite end faces includes an inwardly extending portion that extends inwardly toward a center longitudinal axis of the elongate member and toward the inwardly extending portion of the other opposite end face.

13. The elongate track of claim 12, wherein a distance between the opposing inwardly extending portions is greater than a diameter of the first portion of the second hole.

14. The elongate track of claim 12, wherein the inwardly extending portion extends from the second end of the elongate member and to a central portion of the elongate member, but the inwardly extending portions do not reach the first end of the elongate member.

15. The elongate track of claim 1, wherein the elongate member is symmetrical about a central longitudinal axis that extends between the first and second ends of the elongate member.

16. The elongate track of claim 1, wherein the inclined portion of each of the second holes forms an angle within a range of about 80 degrees to about 120 degrees.

17. The elongate track of claim 1, wherein the first portion of each of the plurality of second holes has a depth within the range of about 0.08 inches to about 0.12 inches.

18. The elongate track of claim 1, wherein the second hole is configured to accept a countersink rivet, such that when the elongate member is positioned upon a planar surface with the second side facing the planar surface, the second end surfaces of each of the first and second end faces and the truncated conical projections of each of the second holes contacts the planar surface.

19. A method of manufacturing an elongate track, comprising:
extruding an elongate rigid member that extends between first and second ends;
aligning the elongate rigid member longitudinally with a first punch configured to form a first hole in the elongate rigid member and a second punch configured to form a second hole in the elongate rigid member, wherein the first hole is rectangular, and the second hole is formed from first and second coaxial sections, a first truncated conical section and a second cylindrical section that extends from a truncated end of the truncated conical section;
punching the elongate rigid member through a first side of the elongate rigid member with the first and second punches to form the first and second holes, respectively;
translating the elongate rigid member longitudinally with respect to the first punch and the second punch to form another first hole and another second hole in the elongate rigid member that is spaced from the earlier punched first and second holes,
wherein the second punch is configured to establish a truncated conical projection that extends from a second side of the elongate rigid member, opposite from the first side, the truncated conical projection surrounding and coaxial with the second hole.

20. The method of claim 19, wherein the punching and translating steps are performed such that the first and second holes are aligned adjacent to each other along a first length of the elongate rigid member in a pattern of first hole, second hole, first hole, and second hole.
